(19) United States
(12) Patent Application Publication
(10) Pub. No.: US 2005/0190199 A1
(43) Pub. Date: Sep. 1, 2005

(54) Apparatus and method for identifying and simultaneously displaying images of musical notes in music and producing the music

(76) Inventors: Hartwell Brown, Palo Alto, CA (US); Goodwin Steinberg, Palo Alto, CA (US); Robert A. Grimm, Los Altos, CA (US)

Correspondence Address: DORSEY & WHITNEY LLP;INTELLECTUAL PROPERTY DEPARTMENT, 4 EMBARCADERO CENTER, SUITE 3400, SAN FRANCISCO, CA, 94111, US

(21) Appl. No.: 11/021,828

(22) Filed: Dec. 22, 2004

Related U.S. Application Data
(63) Continuation-in-part of application No. 10/028,809, filed on Dec. 21, 2001, now Pat. No. 6,791,568.
(63) Continuation-in-part of application No. 10/247,605, filed on Sep. 18, 2002.
(60) Provisional application No. 60/532,413, filed on Dec. 23, 2003.

(51) Int. Cl. G09G 5/02; A63H 5/00; G10H 7/00; G04B 13/00

(52) U.S. Cl. 345/600

(57) ABSTRACT

Our invention is an apparatus and method to identify and simultaneously visualize and hear musical notes contained in an analog or digital sound wave. Musical notes are expanded into a language for the eye as well as the ear. An analog-to-digital converter processes an analog sound wave to provide a digital sound wave. Component frequencies of the digital sound waves are identified, filtered and translated to their corresponding musical note and volume. As the original digital sound wave is sent through a digital-to-analog converter and output to an audio device, the identified musical notes are synchronously output to a display device. User-specified parameters, adjustable at any time before, during or after the music-playing process, control frequency filtering, the graphic display of the identified musical notes and the graphical background on which the musical notes are displayed. Users may also utilize existing, or create their own, computer programming code software modules, known as plug-ins, or hardware components, to interface with the invention to extend and control the invention's functionality. Because the synchronous musical note identification and visualization process occurs extremely quickly, the method applies and works in real-time for live music.

### CROSS-REFERENCES TO RELATED APPLICATIONS

This application is a Continuation-in-Part of U.S. patent application Ser. No. 10/028,809 filed Dec. 21, 2001, entitled ELECTRONIC COLOR DISPLAY INSTRUMENT AND METHOD, now U.S. Pat. No. 6,791,568, and U.S. patent application Ser. No. 10/247,605 filed Sep. 5, 2002, entitled COLOR DISPLAY INSTRUMENT AND METHOD FOR USE THEREOF, and claims priority to U.S. Provisional Patent Application No. 60/532,413 filed Dec. 23, 2003, entitled A METHOD TO SIMULTANEOUSLY VISUALIZE AND HEAR MUSICAL NOTES CONTAINED IN AN ANLOG OR DIGITAL SOUND WAVE

### BACKGROUND OF THE INVENTION

1. Field of the invention

This invention relates, in general, to an apparatus and method which identifies and simultaneously display images of and reproduce musical notes contained in an analog or digital sound wave in real time, whether the music is live or recorded.

2. Description of Related Art

In many concerts, dance clubs and personal computer media player programs, visual displays, or images, accompany the musical sound. In this manner, both the visual and auditory senses of the audience are stimulated, in an effort to expand the entertainment experience of the audience member, and attract a greater audience.

Generally, in more advanced imaging the display is synchronized with the music. Changes in the music are reflected in changes of the display. For instance, on personal computer media player programs such as Windows Media Player, changes in volume cause the images to change.. The more synchronized the display with the musical sound, the better and more interesting the user experience. Millions of users have downloaded Windows Media Player, and have access to the Media Player images. In our conversations with some of these people, they download Windows Media Player in part because of the visual images.

In fact, one of the justifying features for the pay version of Windows Media Player is that the pay version offers enhanced imaging. Clearly, images are attractive to users, because users are willing to pay additional money to gain access to better images.

The idea that the sound coming out of the speakers is controlling and affecting the display or images on the monitor screen is exciting and enthralling to users, and expands their personal entertainment experience from just the hearing to both the hearing and sight. The closer the correlation between changes in the music and changes on the screen, the better the experience becomes for the user. Instead of a random visual display, the music itself can affect what is seen on the screen.

Since the goal is to synchronize the display or images with the music, the closest possible relationship exists in the musical notes themselves. What could be more synchronous with changes in the music than identifying and visually displaying the actual musical notes contained in the music? Music is made of notes. As the notes change, the music changes. The ultimate potential for display synchronization with music exists in identifying the musical notes. If the musical notes can be identified and visually displayed, the user can actually see the music to which they are listening.

The challenge, of course, is identifying the musical notes. Most music to which people listen on their computers is digital, such as an mp3, compact disc or wav file. This digital music is a pre-mixed and mastered digital representation of a sound wave combining multiple tracks into one sound wave encoded for a digital-to-analog converter that will play the sound out of a speaker.

Measuring the amplitude changes in the sound wave that drive current visualizations is relatively straightforward when compared with determining the notes contained in the sound wave, a significantly more complex endeavor.

The human ear's ability to parse and identify the component frequencies contained in a sound wave is astonishing. Replicating what the human ear does is a phenomenally difficult undertaking, as anyone who has used a hearing aid or talked with someone who has can attest. The sound waves coming out of the speakers are sensed by the ear, processed by the auditory complex of the brain and identified as musical notes. To visually display these same notes, a computer program needs to first identify the notes.

Once identified, these notes would need to be visualized in a recognizable, appealing and user-adjustable manner, with volume affecting the size of the notes, and to be displayed synchronously on the screen as the original sound wave is output to the speakers. Ideally, to fine-tune their viewing experience, users could also set a note recognition threshold based on the frequency or volume to determine what component frequencies make their way past the frequency filtering process and onto the screen. A user may want to give only the most predominant notes, usually the primary melodies, or all of the harmonics in the background, or somewhere in-between.

Up until a few years ago with the advent of advanced, mass-produced microprocessors, the computer processing power necessary to accomplish the above was unavailable and impractical for the general computing public. However, the required computing power, when combined with efficient programming algorithms and multithreading, is now readily available in the majority of personal computers available today.

What is needed is the ability to identify the musical notes and displaying them in a user-adjustable or predetermined manner while synchronously playing the musical notes. However, musical notes contained in a digital music file are not the only source of music. In fact, in order for a recording to exist, there must be the live music that is being recorded or generated. What about being able to visualize music as it is being created? What about a trumpet solo, or barbershop quartet harmonizing an anthem? What about a live electronic performance, with synthesizers, guitars or drums? What about the live playing of MIDI instruments? Why should listening to and seeing musical notes be limited to recordings? To answer these questions and visualize musical notes as they are being created requires the “holy grail” of current computer music research—real-time, automatic music transcription.

If the note identification and visual synchronization process was sufficiently efficient, live musical notes could be seen as well as heard. A slight processing delay of around six milliseconds could exist, but for all practical intents and purposes, the invention would work in real time for live music. Instead of receiving the digital sound wave samples from a recorded digital file, the samples could be captured directly as they were input into a computer sound card. By plugging a microphone into the sound card of a computer, and using the invention, live musical notes could be automatically transcribed and visualized in real time in synchronization with the production of the live music. The music input could be recorded analog music rather than live music.

The user should have the option of setting the note recognition threshold and adjusting the note display, color, location and background for live music and recorded music.

More sophisticated users may want to customize, create and control their own note recognition algorithms and displays for the musical notes contained in music. To address this need, users can create their own modules of programming code, or plug-ins, to extend, modify or augment functionality.

Once the musical notes were identified, the display characteristics of the notes is another area for which a user could create exactly their desired display for musical notes themselves. These users could aesthetically pursue beautiful, kinetic art that visualizes the notes contained within music synchronously as the music plays.

Furthermore, with the invention, existing graphical computer art and animation could be transferred to plug-ins to display musical notes as the music plays. Graphic artists and designers could explore new markets for their work, and expand their work beyond static art to kinetic art if they so desired, and to kinetic art applied beautifully within the system and correlation of the musical notes contained in a sound wave.

What is needed is the ability to provide a display controlled by the music as the music is playing in real time, whether as a recorded sound wave or a live sound wave, whether digital or analog, where users can make adjustments to the visualization either before the music plays or in real time as the music plays, and where users can create their own plug-ins for note recognition and note visualization.

### SUMMARY OF THE INVENTION

The present invention identifies the musical notes contained in a sound wave, whether recorded or live or digital or analog, and synchronously in real-time, calculates the intensity or volume of the musical notes, filters the results according to user-specified and adjustable parameters, and visually displays the musical notes according to user-specified and adjustable parameters on a visual background, whether static or kinetic, with the background displayed according to user-specified and adjustable parameters, as the user hears the sound wave containing the musical notes. Users may adjust the note recognition and visualization parameters at any time before or during music playing, and extend note recognition and note visualization functionality if desired by creating their own or utilizing existing plug-ins. In accordance with another feature of the invention as music plays, the identified musical notes are visually displayed when the musical notes are no longer present in the music, the musical notes cease to be displayed. If no notes are present in the music, as in the case of silence before, within or after the music playing, no notes are displayed.

If the music source is a recording of a sound wave, the original recorded sound wave is synchronously output to an audio device as the musical notes are graphically displayed on a display device. If the music source is a sound wave generated by live music as the artist performs, then there is no need to output the audio, because the artist creates the audio as they perform. However, the live music audio must be input into our invention, usually by a microphone through an analog-to-digital converter and then processed. Live musical notes and their intensity, i.e. volume, are identified, filtered and visually displayed with a slight delay of less than six milliseconds. However, such a slight delay is interpreted by the eye and ear as occurring in real time.

Pursuant to the invention users can select and adjust at any time the parameters for note recognition and note visualization, either before or during music playing. Users can also create their own note recognition and note visualization plug-ins that interface with our invention to produce the user's desired result, or utilize plug-ins that other users have created.

There is described an apparatus and method to identify and simultaneously displaying and playing the musical notes contained in a sound wave in real time for a live music or recorded music which has a display for displaying images, a sound generating device and a processor with means to analyze the component frequencies contained in the music, determine the volume of the component frequencies contained in the music, filter the component frequencies, translate the filtered frequencies to their corresponding musical notes, graphically display all identified musical notes on the display, and synchronize the graphic display of the musical notes with the generated sound.

### BRIEF DESCRIPTION OF THE DRAWINGS

The foregoing and other objects of the invention will be more clearly understood from reading the following description of the invention in conjunction with the accompanying drawings in which:

FIG. 1 is a block diagram of the apparatus for identifying and displaying images of musical notes in music and producing the music;

FIG. 2 is a flow chart showing how the source of the sound wave is identified;

FIG. 3 is a flow chart for showing converting the identified sound into the Pulse Code Modulation (PCM) data format to digitally represent an analog sound wave;

FIG. 4 is a flow chart showing how the musical notes present in the PCM data are identified;

FIG. 5 is a flow chart for how Note On and Note Off messages are generated and sent to the musical notes display;

FIG. 6 is a flow chart of how a musical note frame display is generated from the Note On and Note Off messages;

FIG. 7 is a flow chart detailing how the display of the identified musical notes is synchronized with the audio generation of the sound wave containing the identified musical notes;

FIG. 8 is a flow chart detailing the initialize call back process;

FIG. 9 is a flow chart detailing the process used to measure CPU Usage to reduce processor load if the graphical display requirements exceed the processor's ability to complete them in time to display at the specified frame rate, in accordance with the present invention; and

FIGS. 10-13. show screen shots of typical displays created with the present invention.

### DETAILED DESCRIPTION OF THE INVENTION

The following description details an implementation of the invention and possible applications. It is by no means, way, shape or form intended to limit the scope of our invention. It is merely intended to teach one implementation, and not to limit the invention to this embodiment. The invention is intended to apply to alternatives, modifications and equivalents which may be included within the spirit and scope of our invention as defined by the appended claims.

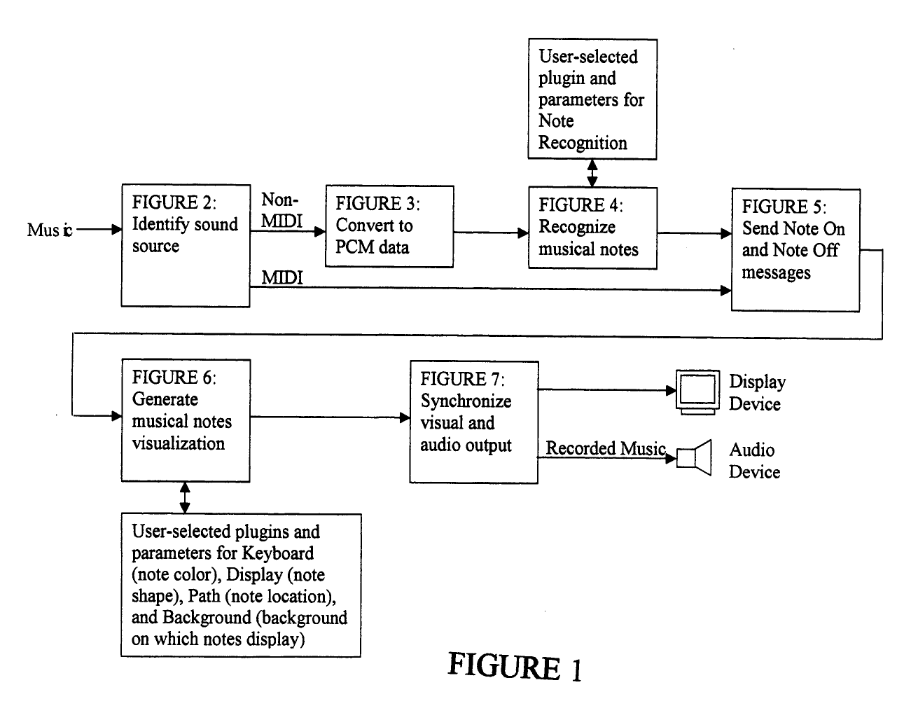

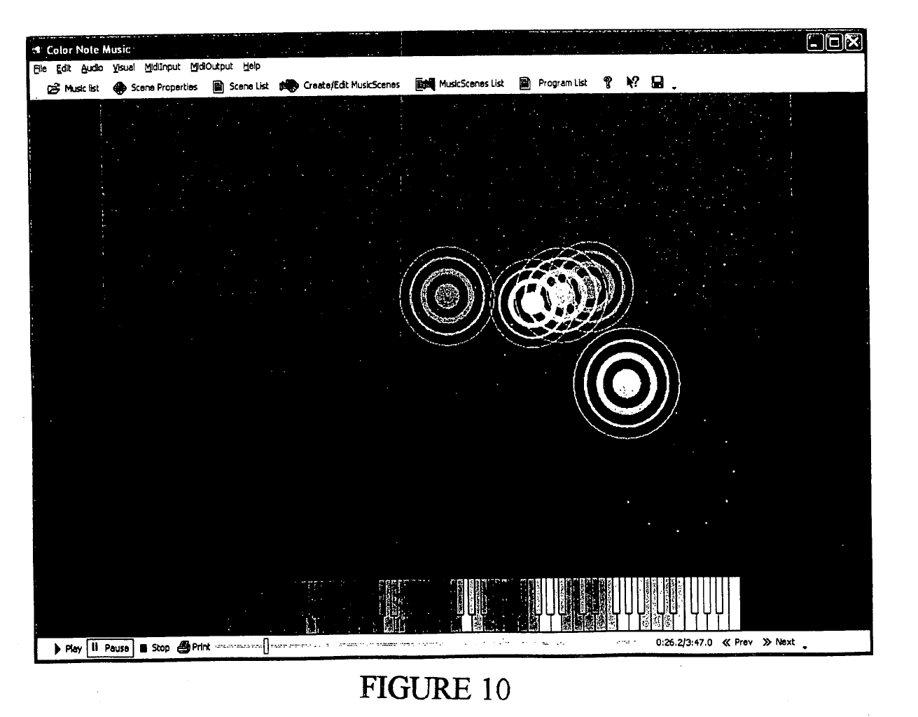

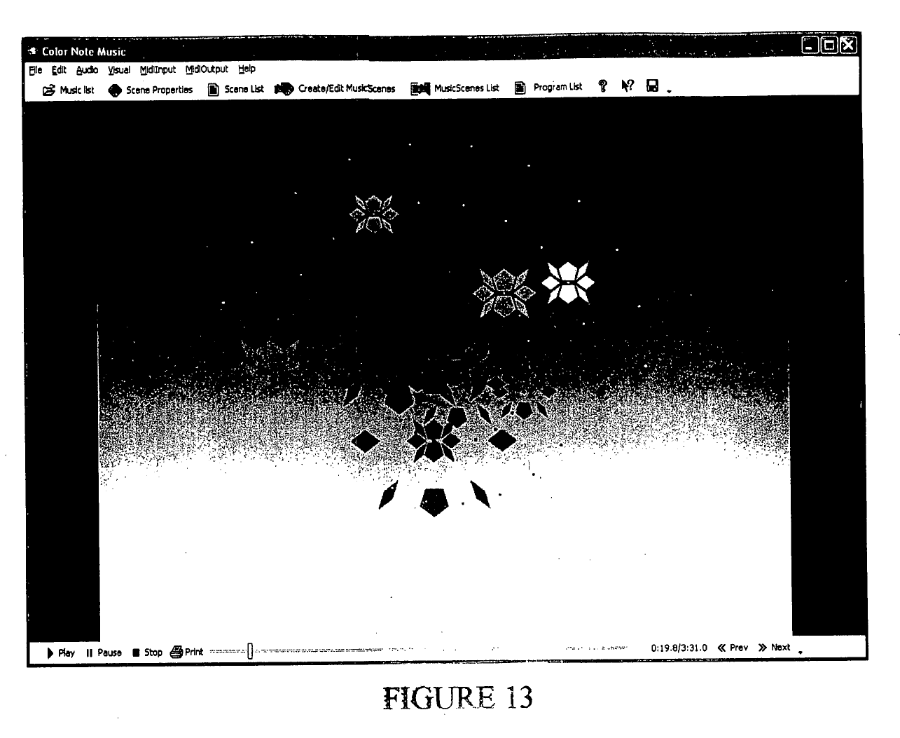

FIG. 1 provides an overview of the processor steps, from start to finish. Briefly, the processor processes the input music and provides a visual display representing note and audio output music with the display synchronized to the music. The user inputs music and the source of the music is identified, converted to digital data which is processed to recognize musical notes. The notes are then converted to display shapes having selected configuration and displayed at selected locations on a display as the music is played in synchronism. Typical displays are shown in FIGS. 10-13.

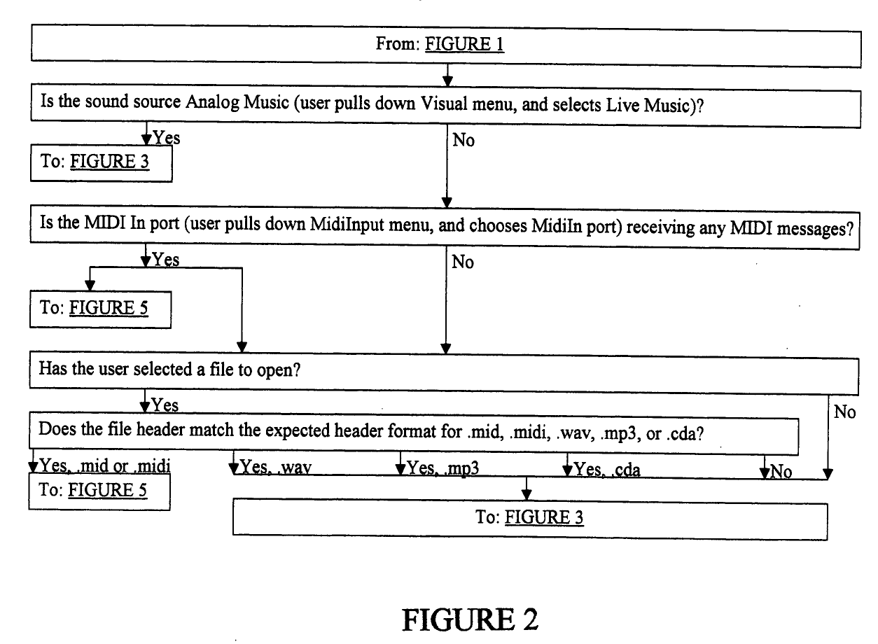

FIG. 2 details how the sound source is identified. The first step is to discern if the sound source is Live Music or analog music. The user pulls down the Visual menu and selects Live Music, the user tells the processor that the sound source is live music. In this context, “live music” indicates an audio generating device such as the human voice, or a musical instrument such as a physical trumpet or trombone or acoustic guitar, is generating an analog sound wave. Certainly, more than one audio-generating devices can be combined to produce an analog sound wave, such as in a band, or choir, or symphony orchestra. Also, multiple analog sound waves from isolated sources could be combined, such as artists in individual sound booths simultaneously performing in a recording studio.

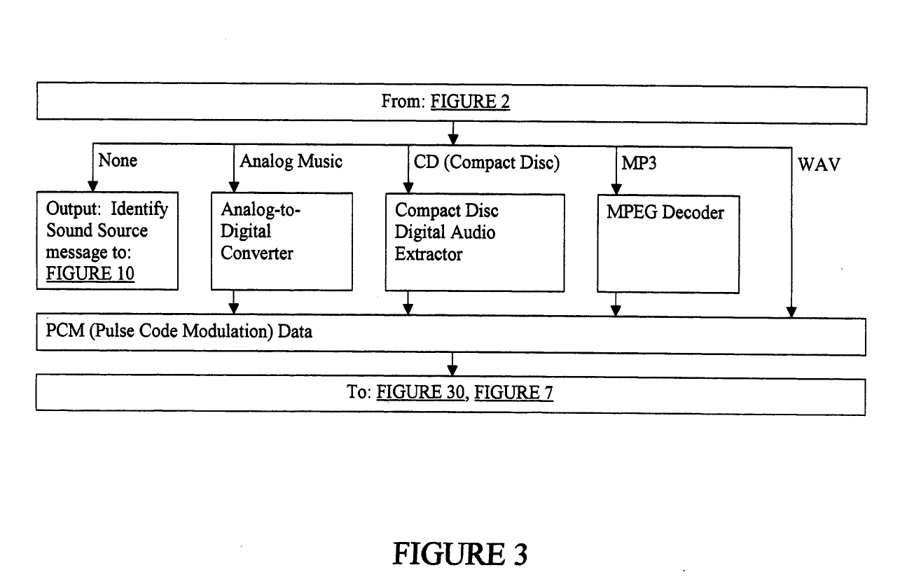

Typically with live analog music, a microphone placed within range of the sound source is connected to the Line In port on a sound card on the computer processor on which the application is running. In this context, “port” indicates a place where a connection can occur between a device and the computer. Certainly, not just a microphone, but any device that converts an analog sound wave into a computer-readable representation of the sound wave, may be used to provide a musical input into our invention. If the sound source is Live Music, i.e. the user pulls down the Visual menu, and chooses Live Music, then a sound source has been identified as Live Music, and a message is sent to FIG. 3 where the sound is digitized to provide PCM data.

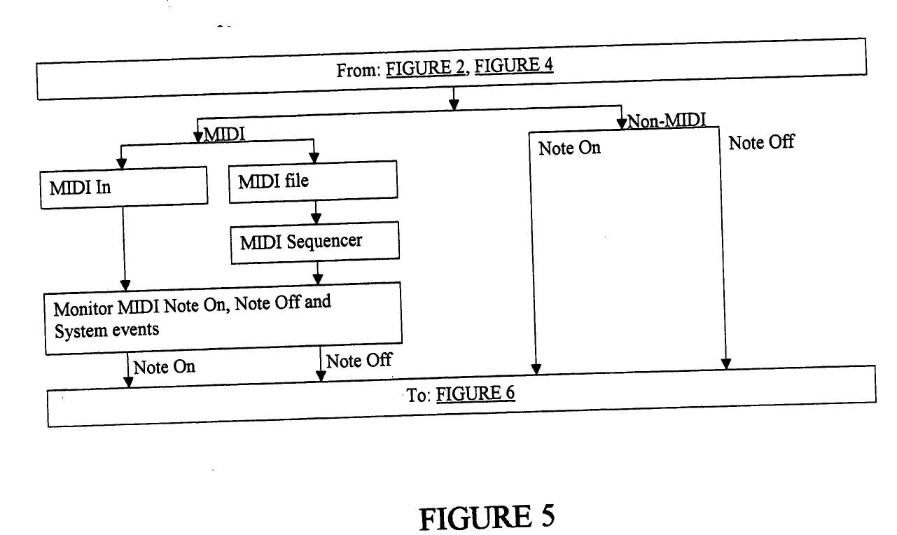

It may be, though, that the user has a Musical Instrument Digital Interface (MIDI) instrument connected to the MIDI In port on the computer implementing our invention. To address this situation, the application monitors the MIDI In port for MIDI event messages. In the event that multiple MIDI In ports are connected to the computer, the user can pull down the MIDI Input menu, and choose their desired MIDI In port to monitor. If just one MIDI In port exists, that MIDI In port is automatically selected by the application. If any MIDI event messages are received by the monitored MIDI In port, then the MIDI In sound source is identified a Sound Source MIDI in message is sent to FIG. 5.

Certainly, several MIDI In instruments may be connected together, and their combined input may be sent to the monitored MIDI In port. For instance, if a band had MIDI drums, a MIDI synthesizer piano keyboard, and two MIDI guitars, then the combined MIDI input from all musical instruments, live and in real time, can be sent to the monitored MIDI In port. If the band members were also singing, then microphones could be placed in front of each singer, their input could be combined in a mixing board, and the mixed or raw output could be sent to the Line In port on the computer running the application. In this way, the entire live musical output of the band could be input into our invention. More than one sound source can be identified in and processed by our invention.

After checking for Live Music and MIDI In music, the next step, FIG. 2, is to determine if the user is opening a computer-readable file with a recorded digital representation of an analog sound wave. In this context, “file” means a related collection of data bytes, where “bytes” represent the unit of storage for a computer-readable medium. If the user has selected a music file to open, the music file will provide a way of identifying the format used to digitally represent an analog sound wave. This information is usually contained within the file header. In this context, “header” means a related collection of data bytes that occur near the beginning of the file. However, as long as a way exists to identify the format for the digital representation of the analog sound wave, our invention can process the computer-readable file.

The computer-readable file selected by the user may be a MIDI file. If the file header conforms to the MIDI protocol, then the MIDI sound source is identified, and FIG. 2 outputs the Sound Source Identified: MIDI message to FIG. 5.

The note identification process in a MIDI file is straightforward, because the musical notes are represented by Note On and Note Off events, where “events” represent a collection of data bytes conforming to the MIDI protocol for identifying data contained in the MIDI file. The MIDI protocol for a Note On event includes the musical note number, the musical track to which the musical note is associated, and the velocity, or volume, for the musical note. The MIDI protocol for a Note Off event includes the musical note number and track. By inspecting the MIDI file for all Note On and Note Off events, the musical note identification process can occur.

Though the musical note identification with MIDI music is straightforward, MIDI music is limited to the sounds supported by the MIDI protocol, instead of any sound that can occur. Consequently, digital music represented in Pulse Code Modulation (PCM) format is immensely more popular. PCM data can encode any sound wave, including voice, something beyond the current capability of MIDI. Many songs involve complex, intricate sound waves with voice, and PCM data has been adopted as an industry standard for digitally representing a sound wave.

PCM data is commonly experienced in three forms: MP3, CD, and wav. MP3 stands for Motion Picture Experts Group (MPEG) Layer-3, or MPEG-3, or mp3. CD is a Compact Disc. WAV is PCM data, and called WAV because the file extension for said formatted file on PC computers is .wav.

Because the vast majority of music to which people listen on their computers is mp3, CD, or wav, the computer-readable file selected by the user may be a mp3, CD or wav file. If the file header conforms to the mp3 protocol, then the MP3. sound source is identified, and FIG. 2 outputs the Sound Source Identified: MP3 message to FIG. 3. If the file header conforms to the CD protocol, then the CD sound source is identified, and FIG. 2 outputs the Sound Source Identified: CD message to FIG. 3. If the file header conforms to the wave protocol, then the WAV sound source is identified, and FIG. 2 outputs the Sound Source Identified: WAV message to FIG. 3.

It should be noted that our invention is applicable to any standard way of digitally representing an analog sound wave. Though PCM data represented as a CD, mp3 or wav file is the current generally accepted standard for digitally representing an analog sound wave, other data formats for digitally representing an analog sound wave exist, and will likely be developed in the future. Because PCM data is the current industry standard, PCM data is used in this description for one embodiment of our invention. However, our invention applies and is relevant for any standard for digitally representing an analog sound wave, both with alternate existing standards and with standards yet to be developed.

If no recognizable sound source exists, then FIG. 2 outputs the Sound Source Identified: No message to FIG. 3.

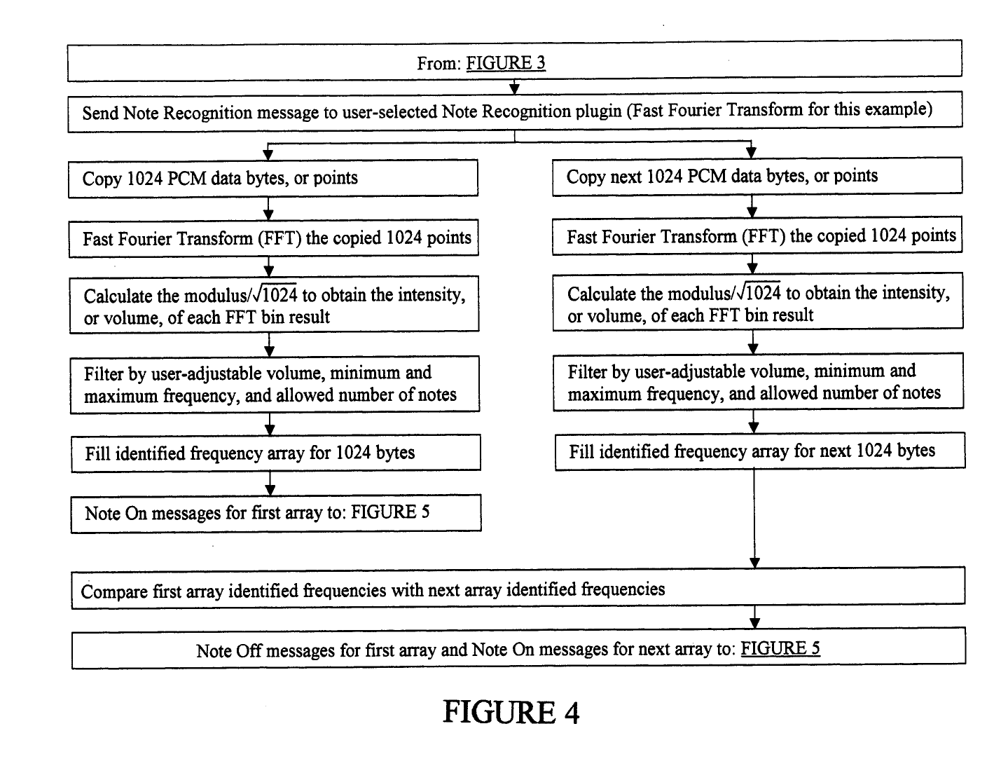

Once the sound source has been identified FIG. 2, all non-MIDI music sound sources proceed to FIG. 3 for conversion to PCM data. Once the PCM data is obtained, the musical note identification process can occur FIG. 4.

If no sound source exists, the application loops back to FIG. 1, waiting for a sound source.

If analog music is the sound source, then the analog music is converted through an analog-to-digital converter into PCM data. FIG. 3 then outputs the PCM Data Ready, Live Music message to FIG. 4.

If a CD file is the sound source, then the CD file is converted into PCM data through a Compact Disc Digital Audio converter. FIG. 3 then outputs the PCM Data Ready, CD message to FIG. 4.

If a mp3 file is the sound source, then the mp3 file is converted into PCM data through a MPEG Decoder. FIG. 3 then outputs the PCM Data Ready, MP3 message to FIG. 4.

Once the PCM data is obtained, it is analyzed, FIG. 4. In the first step the application looks up the user-selected plug-in for the Note Recognition. In this context, “plug-in” means a module of software programming code that conforms to application specifications to interface with the application, such as a Dynamic Link Library (.dll) file. The plug-in receives messages from the application or other plug-ins, and responds to the messages as designated within the plug-in.

The advantage of using a plug-in architecture to perform the musical note recognition is that any user can write their own software code to perform their desired note recognition on the PCM data, as long as they support the interface and specifications delineated in the software development kit (SDK) included with the program implementing our invention. Using the SDK, a user can create and implement their own note recognition plug-in.

One extensive current computer music research topic is automated music transcription, where the goal is to identify the musical notes contained in a sound wave. Myriads of different approaches have been used, including but not limited to, spectral-domain based period detection including Cepstrum spectral pitch detection, Maximum Likelihood spectral pitch detection, Autocorrelation spectral pitch detection, Fourier Transformation, Fast Fourier Transformation, Short Time Fourier Transformation, Gabor Transformation, and others; time-domain based period detection including Fourier Transformation of the sound wave, Fast Fourier Transformation, Short Time Fourier Transformation. Gabor Transformation, Derivative function zero-crossing or Glottal Closure Instant analysis, Windowing analysis with window types such as Bartlett, Welch, Hamming, Parzen, Hann, Blackman, Lanczos, Gaussian, Kaiser, Bohman, Notall, Tukey and Blackman-Harris, and other spectral-domain based period detection; a combination of spectral (frequency) and time-domain based period detection, such as Wavelet transformations and others. All of these approaches, and any other way of attempting to identify the musical notes contained within a sound wave, may be incorporated into a plug-in, and used by our invention to process the musical notes contained in a sound wave in real time for live or recorded music.

For the purposes of illustration, a Fast Fourier Transform (FFT) plug-in is selected. A FFT is one method to identify the musical notes contained in a sound wave. In the first step, FIG. 4, with the FFT plug-in selected, the application sends the Note Recognition message to the plug-in.

A FFT requires a sample size number that is a power of 2, such as 256, 512, 1024, 2048, etc. What we determined to be a workable PCM data sample size was 1024 data points, or 1024 bytes. By matching the PCM data buffer size with the FFT buffer size, the samples can be synchronized for the audio and visual output.

After the first 1024 bytes of PCM data are copied, the next step is to FFT the data samples. The output of a FFT is called a bin. The FFT note recognition plug-in inspects the bin and converts the bin data points to their frequency. All frequencies below 26 Hz and above 4,500 Hz are eliminated to cut out visual noise. The human ear has great difficulty distinguishing any sounds below 26 Hz. For the upper range, 4,500 Hz was selected because it is slightly higher than the highest note on a standard piano keyboard, and the majority of musical notes present in music are contained in a standard piano keyboard. Frequencies up to 20,000 Hz can be detected by the human hear. However, displaying all of these frequencies becomes impractical, in that they are used far less than the other frequencies, outside normal pleasant vocal range, and would leave too little room to display all the other musical notes. Some of the harmonics for notes are contained in these higher frequencies, though, and are present in the original PCM data output to the speakers.

After filtering by minimum and maximum acceptable frequency, a user-adjustable frequency intensity, or volume, threshold is queried by the program. Each FFT point's complex number modulus (the square root of the square of the real number plus the square of the imaginary number) is calculated, and then divided by the square root of the number of points (1024) to normalize the intensity. This result is then compared with the note recognition threshold. If the intensity is higher than the threshold, then the frequency is stored in the identified frequency array, along with the modulus to indicate intensity, or volume. This parameter and other parameters are user-adjustable at any time before or during music playback by clicking a command button to open a dialog box and select the desired Note Volume Filter.

If a user wanted to select a different acceptable frequency range, they may do so, either by using the dialog box interface to the FFT note recognition plug-in, creating their own note recognition plug-in, or using another note recognition plug-in. Our invention provides the flexibility for a user to choose their own acceptable note range, for instance, if only the note range for the vocals in a song was desired to be visualized and synchronously heard.

Identified frequencies are then matched with their corresponding musical note. An 88 note visualization system was developed to mirror the 88. notes on a standard piano keyboard. Each present identified frequency is rounded to the nearest musical note, accounting for the event that the found FFT frequency falls in between the musical note demarcations of a standard piano keyboard.

When a musical note clears the frequency and volume filters and is identified, that event triggers a Note On message for the program to visually display the note with the volume of the note determining the user-adjustable size of the note. The found musical notes for the first 1024 PCM data samples are stored in an array, and FIG. 4 outputs the Note On messages to FIG. 5.

In the second column FIG. 4, the next 1024 PCM data bytes are FFT'd. The results are compared with the FFT results of the first 1024 PCM data samples. In this manner, the Note Off messages are obtained. As soon as a found musical note in the first array is no longer present in the next array, FIG. 4 outputs a Note Off message to FIG. 5.

It is certainly possible to further analyze FFT results to determine the musical instrument that has generated the note, and include this information in the Note On messages sent to FIG. 5. Our invention is applicable to any analysis of a digital representation of a sound wave. Also, many of the computer music researchers at universities, institutes and companies around the world use the computer software program MATLAB to develop software routines to examine and analyze digital representations of sound waves. Because these routines are developed for MATLAB, the researchers are unable to apply their work in real time to live music. With our invention, they are now able to do this, and it should be fascinating to see the results of the MATLAB routines, and other written programming code, put into Note Recognition plug-ins and used with our invention to work in real time for live or recorded music.

Furthermore, other filtration techniques for identifying musical notes are possible other than examining the modulus, including, but not limited to, Daubechies filters to determine zero-crossing instances, Maxima Detection combined with Wavelet Transformation analysis, median filters applied to Maxima Detection, comparison of two or more overlapping Windows segments, comparison of any combination of overlapping or non-contiguous Windows segments, signal energy threshold control, pitch variation strength threshold control, or any combination thereof. Our invention applies to these and other musical note filtration techniques. The method may vary for obtaining the Note On and Note Off messages.

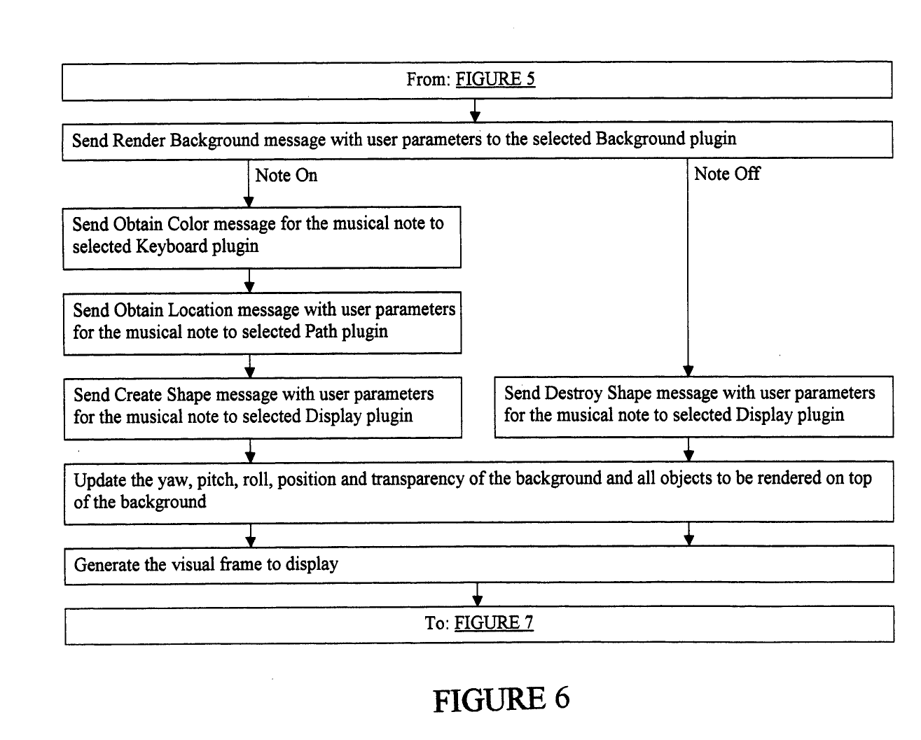

FIG. 5 packages the Note On and Note Off messages and sends them to FIG. 6. Any Note On and Note Off messages received from FIG. 4 are assembled into a Note On and Note Off data packet. The Note On data packet includes information about the musical note such as the number, the track for the musical note, the instrument producing the musical note if identified, and volume. The Note Off data packet includes information about the musical note such as the number, the track for the musical note, and the instrument producing the musical note if identified.

If the music source is MIDI, as illustrated on the first column of FIG. 5, and the source is MIDI In, then the MIDI Note On, Note Off and System events are monitored. As soon as a Note On or Note Off MIDI event occurs, a corresponding Note On and Note Off data packet is generated and output to FIG. 6. If a System event occurs involving Note On or Note Off, events occurs, the appropriate Note On and Note Off data packets are generated and output to FIG. 6. If the music source is a MIDI file, then the MIDI Note On, Note Off and System events are identified by a MIDI Sequencer. The corresponding Note On and Note Off data packets are generated and output to FIG. 6.

FIG. 6 takes the Note On and Note Off messages from FIG. 5 and constructs the frame to be rendered on the display device. In this context, “frame” means the entire visual content shown at one point in time. “Frame” corresponds to the video use of frame, where a video occurs at fifty frames per second, or where fifty images are shown in one second, or one frame every 20 milliseconds, where a millisecond is one-thousandth of a second.

To generate the frame containing the musical note visualization, three questions are addressed. First, what is the background on which the notes display? Second, what does the note look like when it displays? And third, where does the note display? Typical frame displays are illustrated by screen shots shown in FIGS. 10, 11, 12, and 13 where the notes are displayed as circles, flowers and hexagons on different backgrounds along a line, spiral or circles with different notes in different colors.

The user-selected Background either programmed in the processor or in a plug-in determines the background on which the notes appear. A Background plug-in is a plug-in that conforms to the Background plug-in specifications and responds to the Render Background application message. Users can determine their desired background and set their desired background parameters by selecting or configuring a background plug-in.

Setting the color of the background can affect the entire mood of the visual experience of seeing the notes as they play from speakers. A tango piece's musical notes witnessed on a black background give an entirely different feel of that same tango piece's musical notes on a red background. Our invention enables the user to select and change the background and background parameters in real time as music is playing, whether live or recorded.

Another background plug-in is a gradient background. Quite complex and intricate patterns arise with gradient backgrounds. Both the beginning and ending gradient colors are controlled by the user, and encompass the entire range of displayable colors on the monitor. In this described invention implementation, even the direction of the gradient can be selected, be it 12 o'clock to 6 o'clock, or 3 o'clock to 9 o'clock.

Visually displayed notes can also be shown on a moving, kinetic background. The background can be the aforementioned Windows Media Player visualizations if the background plug-in draws the Windows Media Player visualization when it receives the render background message, with the musical notes displaying on top of the visualization as the music plays.

Full motion video can also serve as the background, or a series of still images, similar to a slide show. A video of wind blowing and rustling through wheat fields can be playing as the background and paired with sweeping music, with the identified notes displaying in their designated location and with their designated user-defined characteristics. A popular music video can be playing, with the musical notes in the song showing underneath the video as sheet music lighting up in real-time as the song plays. In the event that the program window is resized in this described invention implementation, the program automatically resizes the display window proportionately to maintain the original aspect ratios and preserve the spacing integrity of the desired displayed images.

When the user-selected Background plug-in receives the Render Background message, the background plug-in renders to the frame buffer that will ultimately be displayed on the display device. Any subsequent note visualizations are drawn on top of the background.

Naturally, any number of visualization layers with depth and transparency to control layer ordering and blending may be utilized in creating a musical note visualization.

Once the selected Background plug-in has rendered the background to the frame buffer, the visualization for the musical notes may be generated. Two parts form the answer to how the note displays: the color, and the shape. The color corresponds to the user-selected Keyboard resident in the computer program or as a plug-in where each representable musical note is assigned a color, i.e. look-up tables. A Keyboard plug-in conforms to the application specifications for a Keyboard plug-in and responds to the Obtain Color application message.

One implementation of a Keyboard plug-in is based on the color wheel. The color wheel is used to generate complimentary colors for an octave. Counting sharps, in the Western music system, 12 notes are contained in an octave. Each of the note colors in the octave compliment the other colors. The reasoning behind this is that no matter what musical notes are being played, the different colors will always go well with each other.

The core octave is assigned to the octave containing middle C. Lower octaves keep the same base colors for the octave, but differ in their shading. The lower the musical note, the darker the shade of the note. The higher the musical note, the lighter the shade. For instance, on a Gauguin keyboard plug-in, middle C is red, the lowest C is a crimson, that is almost burgundy, and the highest C is a light pink.

However, the note colors are by no means limited to this structural system. In this described implementation of our invention, the application sends the Obtain Color message to the Keyboard plug-in to request the color for the note. However, the keyboard plug-in can execute a callback function in response to this message, or return the color for the note. In this context, “callback function” means a computer programming function that is called, or executed. This callback function ability enables a collection of colors to apply for a note, or another activity to occur entirely. The creator of the plug-in can determine what happens in response to the Obtain Color application message. For demonstrating this implementation of our invention, though, the user-selected Keyboard plug-in returns the requested, unique note color. In this manner, a note can be instantly identified by its color, and the shade of the color provides the octave containing the note. References to FIGS. 10-13 shows the notes of different color for a color wheel plug-in. Users can of course select a different Keyboard plug-in in real time as the music is playing and thereby instantly change the colors for all recognized musical notes.

By selecting the Keyboard plug-in, the user answers the question of what base color the note will be, if any. Next, the user can determine the location of the note on the screen, or where the note appears when the note plays. The user does this by selecting their desired Path plug-in. A Path plug-in is a plug-in that corresponds to the application specifications for a Path plug-in and responds to the Obtain Location application message.

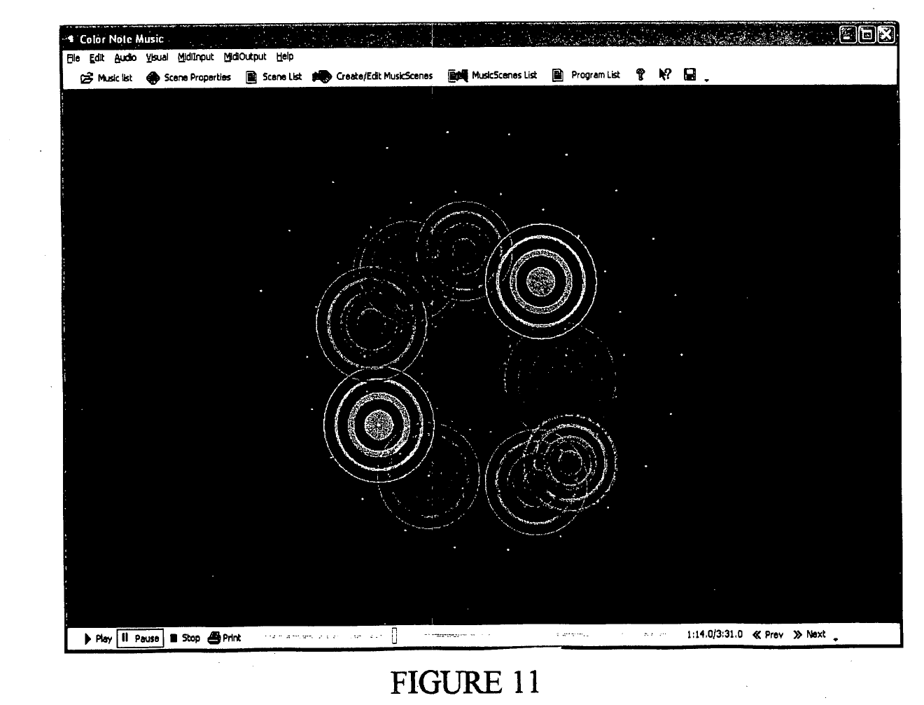

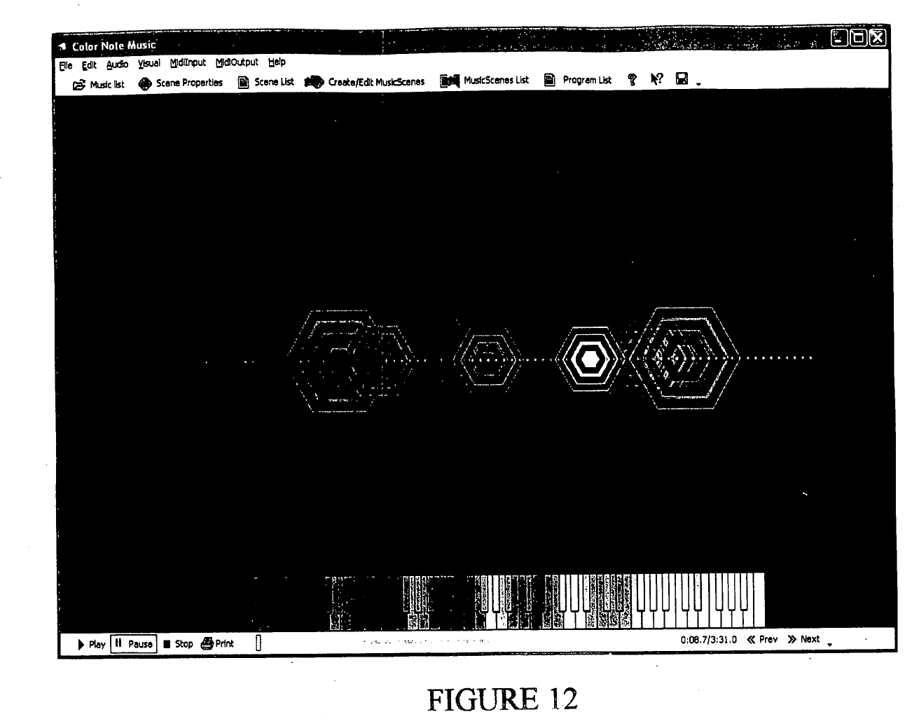

The selected Path plug-in provides the location of each playable note. In the described implementation of our invention, the program sends the path plug-in the Obtain Location message. The Path plug-in returns the coordinates of the note for the x, y and z axis. Path plug-ins can be laid out on the screen as line, FIG. 10, or spiral, FIG. 11, out from the center of the screen, with the lowest notes being at the beginning of the spiral or line, and highest notes being at the outer limits of the spiral. Or, each octave can be represented in a designated portion of the screen in the shape of a circle, FIG. 12, or other orientation. Since most vocals occur in the musical notes contained in octaves three and four on a standard piano keyboard, octave grouping note paths provide a clear way to distinguish the vocal notes being sung in the performance.

If the user desires, the location for each playable note in the path can be shown, with a dot the color of the note showing the location for the note. In this described implementation of the invention, the user can select to display the path, as shown in FIGS. 10-13. The advantage of showing the path is enhanced aesthetic appeal and greater predictability for where the notes will appear.

Paths may also include note location movement if desired by the creator of the plug-in, where a note's location can shift over time, or as the note is playing, as the creator of the path plug-in and the user of the path plug-in desires. With moving paths, a sense of motion and variety may be added to the simultaneous hearing and seeing of the musical notes contained in a sound wave. A path, or the background for that matter, can move in response to detected musical beat, or rhythm, or any specified or random occurrence.

After the Background plug-in, Keyboard plug-in and Path plug-in for the notes have been selected by the user, the user can choose their desired note display, or Shape, plug-in. After sending the Obtain Location application message to the selected Path plug-in, this implementation of our invention sends the Create Shape message to the selected Shape plug-in in response to the Note On message received from FIG. 5.

When a Shape plug-in receives the Create Shape application message, the Shape plug-in creates an object for the musical note and adds the object to the frame to be rendered on the display device, according to the user-specified Shape plug-in parameters. In this context, “object” receive, respond to and generate application messages. The location coordinates for the x, y and z axis returned by the Path plug-in serve as the starting coordinates for the center of the shape.

The base size of the note shape, or display, can be determined by the user, along with other user-adjustable parameters. Note size is based on the percentage of the screen, which maintains the same aesthetic note display proportions and note relationship to other notes regardless of the user-selected monitor resolution. Typically, the louder the note, the larger the plug-in renders the note. Shape plug-ins, along with every other type of plug-in, can create their own dialog box interface, and add a plug-in reference to the application menus and toolbars to invoke a dialog box for the plug-in whenever the user desires. In this manner, the user can make plug-in adjustments in real time as the music is playing, and have complete control over how their musical notes display. Naturally, the user can create their own plug-ins, as well.

When FIG. 6 receives a Note Off message, the object for the musical note is matched, and the selected Shape plug-in receives the Destroy Shape message.

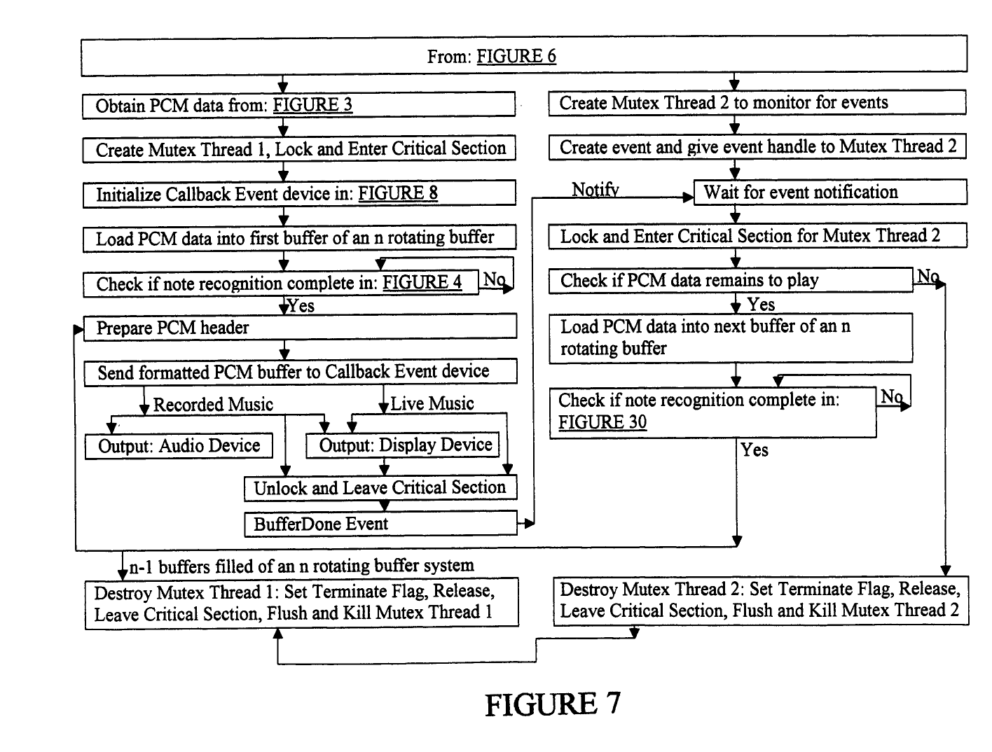

After the Note On and Note Off messages have been processed in FIG. 6, the selected Background plug-in, Path plug-in and Shape plug-in receive the Update application message for all objects attached to the frame to be rendered to the screen. The Background, Path and Shape plug-ins then update parameters such as, but not limited to, yaw, pitch, roll, the yaw, pitch, roll, position and transparency for the background and the transparency for all objects to be rendered on top of the background. When this process completes, FIG. 6 outputs the Frame Render Ready message to FIG. 7.

Displaying the notes requires significant processing capacity, and depending on the complexity of the selected plug-in note visualization, can easily cause a processor to run at maximum capacity, or utilize all available cache memory. On some computer systems, running the processor at maximum capacity for prolonged periods of time can cause unpredictable results and even program crashing.

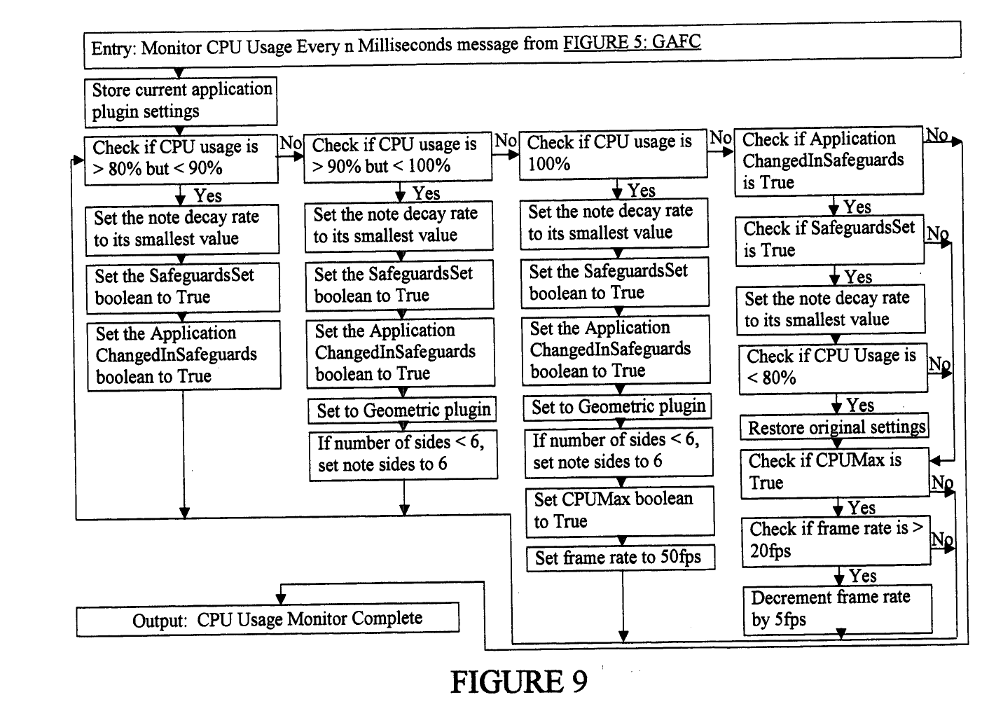

To alleviate this concern, a Central Processing Unit (CPU) Usage Monitoring system is employed as shown in FIG. 9 if the user has selected to activate this feature. After identifying the operating system, the program creates a programming thread in the appropriate manner for the operating system to monitor the CPU usage every n milliseconds. We found that 250 milliseconds was an appropriate interval to use to check the CPU usage and report the level to the application.

If the CPU usage is over 80%, the safeguards begin to activate, as illustrated in FIG. 6: SFC. Current user settings are stored, because if processor use clocks in below 80%, the original user settings are restored in a tuning process that continually monitors and adjusts the display settings based on the percentage of CPU usage.

Selectively gearing down the more CPU-intensive programming features, such as advanced musical note graphical displays like an exploding bubble that continues to expand as long as the musical note is playing, often eases CPU usage.

If CPU usage creeps above 90%, a second tier of safeguards is employed to further ease CPU usage. Here, the note decay rate is set to its smallest value, to minimize the fading time a note remains on the screen and blends into the background after the note has ceased playing.

In the event that CPU usage reaches 100%, drastic measures are taken to immediately reduce the CPU usage. Reducing the frame rate of the display below 50 frames per second (fps) often causes a sharp drop in CPU usage. If CPU usage is still at 100%, the frame rate is decremented in 5 fps increments until the frame rate reaches 20 fps. We found that 20 fps was a practical minimum for the lowest frame rate that could still maintain display quality. On a system that meets the minimum system requirements for the program, CPU usage drops to below 80% at a display rate of 20 fps.

On most computer systems purchased within the last three-to-five years, though, there is no need for safeguards, in that the CPU usage remains under 80% even when the program is using the most complicated display possible. Nevertheless, if a user is running thirty programs at once, or creates an exceptionally processor-intensive note-recognition or visualization plug-in, CPU usage can go up, in which case the safeguards can ensure stable performance, and provide the plug-in with the information that CPU usage is above safeguard thresholds, enabling the plug-in to take action accordingly.

With CPU usage monitored, the issue than arises of how to synchronize the visualization for the recognized musical notes contained in a sound wave with the playing of the sound wave itself out of the audio generating device, such as speakers. For this, a multithreading solution detailed in FIG. 7 is constructed.

Not only do the samples have to be recognized by the selected note recognition plug-in before they are displayed, the samples need to flow continuously into the note recognition plug-in as the song plays. Naturally, a message needs to be sent when there is no more data to load, i.e. the song has finished playing.

The advantage of this approach is that as the song is playing, the impending data samples are being fed into the note recognition plug-in successively, and then visually displayed as the sound sample is sent to the speakers. To have to perform note recognition on the entire song before playing the song would be to cause the user to have to wait for processing, an unpleasant and interrupting process to the personal entertainment experience, and would obviate the ability for real time note extraction and synchronous display and listening. At the other extreme, if each sample was immediately note-recognized and played, cracks and pops in the sound would result from choppy buffer progression during music playing.

A solution to this conundrum is to implement a rotating buffer system, as shown in FIG. 7. A fixed number of buffers are used, which are in turn segments of an allocated memory block to perform and store the note recognition results. The first time a song is opened, the initial data samples are loaded into the buffer system, except for the last buffer. This last buffer is left uninitialized until the first buffer is completed playing. At that point, the last buffer is initialized with the next segment of the song. The played buffer is flushed, and stores the next song segment, incrementing each buffer up one in the order of playing.

This system is analogous to a rotating stack of paper. The paper on top is the music that plays. As soon as the music on the paper plays, it is erased. The portion of the song that comes after the music stored on the bottom piece of paper is then written onto the paper that has just been erased. The paper with the portion of the song that comes after the bottom piece is placed on the bottom of the stack. This moves all the other papers in the stack up one. This process continues until the song has played in its entirety, i.e. no next song segment exists.

In further detail, FIG. 7, upon entry, creates two mutex threads, Mutex Thread 1 and Mutex Thread 2, that can be locked and unlocked and have a critical section where they receive the attention of the Central Processing Unit to the exclusion of all other non-essential processes until the critical section is released. Locking and unlocking these mutex threads and entering and leaving their critical sections ensures an orderly and predictable musical note visualization and audio synchronization.

Please note, of course, that other programming constructs than a mutex thread can be used, including, but not limited to, semaphore, a programming fiber, more than one programming fiber, or any combination of a mutex thread, semaphore thread, programming fiber, or any computer resource locking and unlocking mechanism.

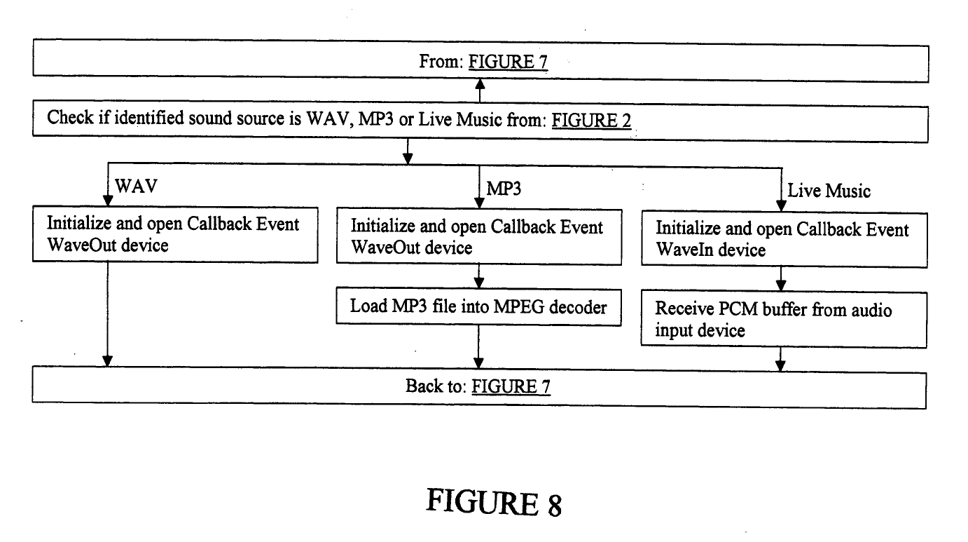

After Mutex Thread 1 is created, a Callback Event device is created according to the sound source identified in FIG. 1. As detailed in FIG. 8, if the sound source is Live Music, then a WaveIn device is created for receiving PCM data samples from the multimedia subsystem WaveIn processing for the computer's operating system. Naturally, any type of device that can accept an optical or electrical or any other type of input meant to represent an analog sound wave can apply. When the WaveIn device is created, application control is returned to FIG. 7.

If the sound source is WAV, as in the case of a wav file or CD file that has converted to wav format through a Compact Disc Digital Audio converter as detailed in FIG. 3, a WaveOut device is created, and application control is returned to FIG. 7. If the sound source is MP3, then the file is loaded into a MPEG decoder that can decode the encoded PCM data as detailed in FIG. 3, the WaveOut device is created for sending PCM data to be output to the audio generating device, usually speakers, and application control is returned to FIG. 7.

After the Callback Event device has been created for the purposes of sending PCM data to the multimedia subsystem to generate the audio represented by the PCM data, the first PCM data segment of 1024 bytes, the same amount that is FFT'd in the Note Recognition plug-in, is loaded into the first buffer of an n rotating buffer system. We found any rotating buffer system of 4 buffers or more proved to be practical.

Once the first buffer is full, the remaining n−1 buffers are filled with the next successive 1024 segments of PCM data. Mutex Thread 1 locks for the first 1024 PCM data samples, enters the critical section, and sends the data samples to the Note Recognition plug-in for note recognition, as detailed in FIG. 4. Mutex Thread constantly monitors the note recognition plug-in for the Recognition Complete message. As soon as recognition is complete, Mutex Thread 1 leaves the critical section, unlocks, the Note On and Note Off messages are sent to FIG. 5, and the visual frame is generated in FIG. 6. Mutex Thread 1 prepares, or formats, the PCM data into a PCM header that can be output to the audio generating device, usually speakers, through the multimedia subsystem for the computer operating system. In the multimedia subsystem, the digital representation of the sound wave goes through a digital-to-analog conversion through the speakers and is output as an analog sound wave. During the time it takes for the PCM data segment to play, the musical note visualization frame is rendered to the display device as shown in FIG. 7, synchronizing the musical note visualization with the audio generation of the sound wave containing the visualized musical notes.

Sending the PCM data wave to the multimedia subsystem triggers the BufferDone event, which activates Mutex Thread 2. Mutex Thread 1 unlocks, and waits until it receives the message to prepare the PCM header for the next segment of PCM data. Mutex Thread 2 locks, takes the next buffer of PCM data, enters the critical section, and sends the PCM data to the Note Recognition plug-in. As soon as recognition completes, Mutex Thread 2 leaves the critical section, unlocks, the Note On and Note Off messages are sent to FIG. 5, the visual frame is generated in FIG. 6, and Mutex Thread 1 transfers control of the PCM data to Mutex Thread 1, where Mutex Thread 1 prepares the PCM header and synchronizes audio and visual output. In this manner, the music plays continually, with a very accurate relationship between the visualized musical notes and playing of the musical notes. In 1024 byte segments, the note identification and audio/visual synchronization occurs one-hundred-eight-nine times a second. This allows for detailed delicacy fidelity to the musical note visualization. For instance, when a singer has a tremolo in their voice, the musical note visualization shows this tremolo, in real time as the tremolo is heard.

This rotating buffer system applies even more efficiently to live music, because live music requires no tracking down or decoding of PCM data. By connecting a microphone to the computer sound card, the sound card or multimedia subsystem converts the incoming electrical signals into PCM data. This PCM data, courtesy of the sound card or multimedia subsystem, is then fed directly into the rotating buffer system and immediately visually displayed as depicted in FIG. 7 with the Output: Display Device steps. This continues as long as data flows from the microphone to the sound card. A slight delay of less than 6 milliseconds to fill the first buffer in the rotating buffer system, plus the time it takes the electrical pulses to be transmitted from the microphone to the sound card to PCM data is inherent in this process, but the musical note identification occurs so quickly that the musical notes display essentially at the same time they become audible to the ear. This is especially true when the audience is seated at a distance from the performance. The time it takes for the sound waves to travel through the air and reach the ears of the listener provides time for the note recognition and display to occur.

Naturally, if the sound source is live music, there is no need to output audio, because the live music itself provides the audio.

During the note identification and musical notes visualization and hearing process, users can change plug-ins and plug-in parameters in real time. Once the note recognition, keyboard, note display, path and background plug-in selections and parameters are made, the user may want to record and preserve their selections, so they may be recalled at any time, saving the user having to remember and recreate a particular combination each time it's desired. As a user convenience in this described invention implementation, individual combinations of plug-ins and settings can be saved collectively as a scene. A scene is a grouping of all selected plug-ins and the settings, or parameters, for the plug-ins, including note recognition, keyboard, note display, path, and background.

Essentially, a scene is a complete user-customized note visualization. Simply by loading a scene, a user can instantly change all of their adjustable display and note recognition parameters. In this described implementation, a Scene List is provided that enables users to view and organize their scenes into Scene Groups, to preview how each scene will look, and to load their selected scene.

Because our invention enables musical notes contained in a sound wave to be identified and simultaneously seen and heard in user-adjustable and customizable ways, and users can save their scene selections, a new art form called MusicScenes in this described invention implementation is possible. A MusicScenes puts a user-selected piece of music and user-selected scenes together in a timed progression set to the piece of music. As the music plays, at the time designated by the user in the music, a new scene loads, with a transition to the new scene ushering in the new scene.

For example, the user can click Create/Edit MusicScenes, and select an mp3. The user can listen to the song, and click the Add Scene command button whenever they want a new scene to load. After selecting the desired scenes and transitions, the user can preview how their MusicScenes will play. To name and save their creation, the user can click Save to title their MusicScenes. To view their creation, the user can click Load. The first scene loads, and the music plays. If a scene change occurs at 15 seconds into the music, at precisely 15 seconds, the scene changes, with the desired scene transition bridging the current scene with the next scene. MusicScenes allow for great visual artistic interpretation and expression for music, because the notes themselves are visualized in the desired manner by the user throughout the entire song. Entire performances can be created and played by creating and saving MusicScenes.

One of the more intriguing aspects of this described implementation of the invention is when the invention receives input from live instruments. The inventors and product testers have witnessed musical visual and audio concerts by artists and musicians who have a musical instrument connected to a computer running this described implementation of the invention. As the musicians begin to play, they realize that the actual notes they play are being visually displayed as they play them. Often, the musicians cease looking at their musical instrument, and focus entirely on the screen. Seeing the notes, they realize that they can control the created visual patterns by what notes and successions of notes they play, how long they hold particular notes, and the volume at which they play the notes. As the visuals become more attractive on the screen, the audible music becomes more beautiful. The result is absolutely mesmerizing and thrilling. It is like witnessing a new art form, and is a riveting, awesome experience.

Yet another application of the invention can be used with multiple instruments, with the identified musical notes of each instrument showing simultaneously in individually designated areas of the screen. The screen could be divided into four parts, one part for vocals, one for drums, one for guitar, and one for piano. As the multiple instruments are being played, the musical notes are displayed in their assigned area.

Our invention can also apply to a symphony or orchestra or choir or group musical live performance where microphones are placed at strategic desired locations, and fed into our invention to extract and display the musical notes being generated in the performance, in real time.

Still another application is where a projection control panel contains the possible plug-ins and parameters, all on one screen. The screen includes access to scenes, MusicScenes, music playlists, pausing, stopping or moving to a different location in the currently selected, playing music, and making visual changes in real time as the music is playing. Only the visual output shows through a connected projector or on another display device. The actions of the user making visual changes to the music in real time as the music is playing are hidden from the viewer. The audience only sees the results of the changes. A live performance or dance would likely be an appropriate venue for the projection control panel invention application.

A related and significant application for our invention is for video jockeys in dance halls and parties, where the video jockey changes projected visuals in real-time to accompany playing music. Video jockeys often like to produce their own visualizations so they can offer a unique product for their performances, and could create plug-ins to match not only changes in volume or a musical beat, but the notes themselves contained within the sound wave that is the music. They could select their own customized visualizations as the music is playing, and have only the output projected onto the viewing area.

It is certainly possible, as well, to create a plug-in that enables users to create plug-ins without needing to write one line of programming code. Essentially, a plug-in for creating other plug-ins would exist. Such a plug-in would have a graphical interface that would enable users to construct what they wanted their to-be-created plug-in to accomplish. When the user was satisfied with their construction, the user could tell the plug-in to create their desired plug-in, and the plug-in would translate the user's construction into an actual plug-in that could then be used with an application embodying our invention. In this manner, no programming experience or capability would be required to generate a plug-in, allowing anyone without a programming background to produce their own desired plug-ins. Naturally, if a plug-in creator did not choose to copy-protect their plug-in, existing plug-ins without copy protection could serve as a basis to create variations on the existing plug-ins, or merely function as a starting point in plug-in creation. A user could select their desired plug-in. That plug-in would load into the editing environment for the plug-in-creating plug-in, and the user would proceed to make any desired modifications. When finished, they could build their new plug-in. In this manner, existing non-copy-protected plug-ins could be used as templates to create other plug-ins.

An alternative application for our invention would be fireworks competitions that offer prizes for the best synchronization of music with the fireworks, because what could be more synchronous with music than the notes themselves? Our invention could extract the desired notes and provide their exact time during music playback. By calculating the firework duration between launch and time-to-burst, and matching launch time plus the time-to-burst with the musical note playing time in the music, the fireworks, if desired, could synchronize note for note with the playing music. They could make live sheet music in the sky.

The potential invention applications are essentially limitless, particularly since users can create their own plug-ins or select existing plug-ins to produce their exact desired synchronous visualization of the notes continued in a sound wave as the music plays. Our invention applies anywhere, but is not limited to, a rigorous, mathematically precise, user-controllable, user-customizable and user-predictable system for simultaneously displaying and playing the musical notes contained within a sound wave.

1. An apparatus for identifying and simultaneously displaying and producing musical notes contained in sound waves in real time for a live music or recorded music, comprising:
a display device;
audio generating device for producing music; and
processor configured to analyze the component frequencies contained in the sound waves,
calculate the volume of the component frequencies contained in the sound wave, filter the component frequencies,
convert the filtered frequencies to their corresponding musical note,
graphically display all identified musical notes on a display device, and
synchronize the graphic display of the musical notes on the display device with the audio generating device producing the music.
a process configured to:
analyze the component frequencies contained in the sound waves, calculate the volume of the component frequencies contained in the sound wave, filter the component frequencies,
convert the filtered frequencies to their corresponding musical note, graphically display all identified musical notes on a display device, and synchronize the graphic display of the musical notes on the display device with the audio generating device producing the music.

2. An apparatus as in claim 1 wherein graphical display of the identified notes comprise shape, color and location of the musical notes on the display device.

3. An apparatus for identifying and simultaneously displaying and producing musical notes contained in sound waves in real time for a live music or recorded music, comprising:
a display device;
audio generating device for producing music;
processor configured to;
analyze the component frequencies contained in the sound wave;
calculate the volume of the component frequencies contained in the sound wave, filter the component frequencies;
translate the filtered frequencies to their corresponding musical note;
provide a color, shape and location for each musical note;
graphically display the medored shapes at said locations on a display device, and
synchronize the graphic display of the musical notes on the display device with the audio generating device producing the music.

4. An apparatus as in claim 3 in which the color, shape and location of the notes on the display is user selectable.

5. An apparatus as in claim 3 where the component frequencies are analyzed by Fast Fourier Transform.

6. An apparatus for identifying and simultaneously displaying images of musical notes in music and producing the music comprising:
a display device;
an audio producing device; and
a processor configured to:
identify the music;
convert selected identified music to a PCM format;
process the converted music to identify musical notes;
provide a color display of the musical notes in selected shapes; and
locations on the display end synchronize the audio output and display.

7. An apparatus as in claim 6 in which the color display is user selectable.

8. An apparatus as in claim 7 wherein the user selects the shape, location and color from look-up tables or plug-ins.
